(19) United States
(12) Patent Application Publication
(10) Pub. No.: US 2011/0022558 A1
(43) Pub. Date: Jan. 27, 2011

(54) Recursive Cause-and-Effect Processing Engine

(76) Inventor: Marc J. Parmet, Camarillo, CA (US)

Correspondence Address: Energics Inc., 5321 San Francesca Drive, Camarillo, CA, 93012, US

(21) Appl. No.: 12/842,979

(22) Filed: Jul. 23, 2010

Related U.S. Application Data
(60) Provisional application No. 61/228,493, filed on Jul. 24, 2009.

(51) Int. Cl. G06N 5/02

(52) U.S. Cl. 706/46

(57) ABSTRACT

This unique smart grid invention is a configurable and flexible event-driven cause and effect inter-process information processing engine, providing continuous processing beyond any single existing smart grid event.

A highly adaptable input and output model provides the unique means for rapid and recursive data processing within the smart grid environment—regardless of the amount of required processing—and can also provide: an alternative set of outcome results in support of multiple consumers of the information, and; a common integration layer platform between disparate smart grid applications for conditional inter-network branching and parallel application processing.

As an event is triggered, the engine's input is processed, with the response directed to a prescribed output delivery channel. The output channel could be subsequent feedback into the cause and effect engine as part of a consecutive loop with differently-directed consuming endpoints, and returned to the cause and effect engine after other subsequent processing.

### CROSS-REFERENCED TO RELATED APPLICATION

This application claims priority to Provisional Application No. 61/228,493 Filed: Jul. 24, 2009 “Recursive Cause and Effect Processing Engine.”

### BACKGROUND OF THE INVENTION

1. Field of the Invention

The field of this invention is data processing, or more specifically, methods, apparatus, and products for the unique intelligent generation, management, storage and distribution of power. This invention provides for a practical and readily available source of recursive smart grid processing that can be easily adopted and readily used by consumers.

2. Description of Related Art

The current industry that supports power generation and distribution is driven by brute force electric connectivity switching across a grid of physical structures that have been part of the public utilities infrastructure for decades. As advances in the thinking of power generation, management, storage, and distribution processing have lead to the consideration of more efficient means to measure and manage services to the public domain, the industry is also faced with the ever-expanding power demands of their supported markets, and, more specifically, how to respond to power events in a timely manner.

With the advent of the SMART Grid, the integration of bridging vendor-specific physical monitoring devices' capabilities to also connect to a background proprietary network connection has enabled communication between available network segments where connectivity is available. While limited by adopted standards, there hasn't been a business motivation to open up the network to share the wealth of information outside the control of the utilities' domain, let alone the ability to chain and manage a real-time series of integrated responses across the network to an event.

Under tight market controls, very little advancement has been made in the utility industry. As a legalized oligopoly with the rights to distribute power without area competition, there has not been a business reason for the power utility industry to modernize their business model to enable outside integration. Today, there exists no alternative to chain and manage a real-time series of integrated responses across the network to an event as a form of intelligent dynamic decision-making capabilities, within either a micro-grid or integrated into existing power macro-grids.

### SUMMARY OF THE INVENTION

This invention is a recursive event-driven, highly flexible and configurable cause-and-effect micro- and/or smart macro-grid processing engine. This invention is a data processing transformation dynamo that reacts upon demand or triggered event(s). This invention focuses on the state of the data before and after it is processed, and uses dynamic translation, transformation, parsing, and filtering before- and after-state transitional mapping to convert one form of information into another.

This invention provides for a processing gateway that can take any input data stream and provide a prescribed output distributed through prescribed delivery channels—including recursively calling itself—which would, in turn, enable itself to be a continually recursive processing engine that could be leveraged across the smart micro- or macro-grid.

Each time a new business or system feature or function is required on the smart grid, it typically involves either writing a new software program or adapting an existing one. This is time-consuming and can be arduous. The business and IT communities need to develop an accelerated method for either: rapidly extending an application's capabilities, readily integrating into another service, or; process for additional capacity and capability.

There is a need to provide users of the smart grid with this very powerful service option, especially ones that lack data integration capabilities for integrating information exchange processes, and the capability to provide recursively chained series of input and output processes and data exchanges together. This invention offers tremendous capacity and an exponential capability to the grid, by enabling this additional capacity and capability to process additional information by simply configuring a chain of events, and defining the inbound source and expected output results.

### BRIEF DESCRIPTION OF THE DRAWINGS

FIG. 1: RECURSIVE CAUSE AND EFFECT PROCESSING ENGINE PROCESS INTERACTIONS DIAGRAM

FIG. 2: RECURSIVE CAUSE AND EFFECT PROCESSING ENGINE SEQUENCE DIAGRAM

### DETAILED DESCRIPTION OF EXEMPLARY EMBODIMENTS

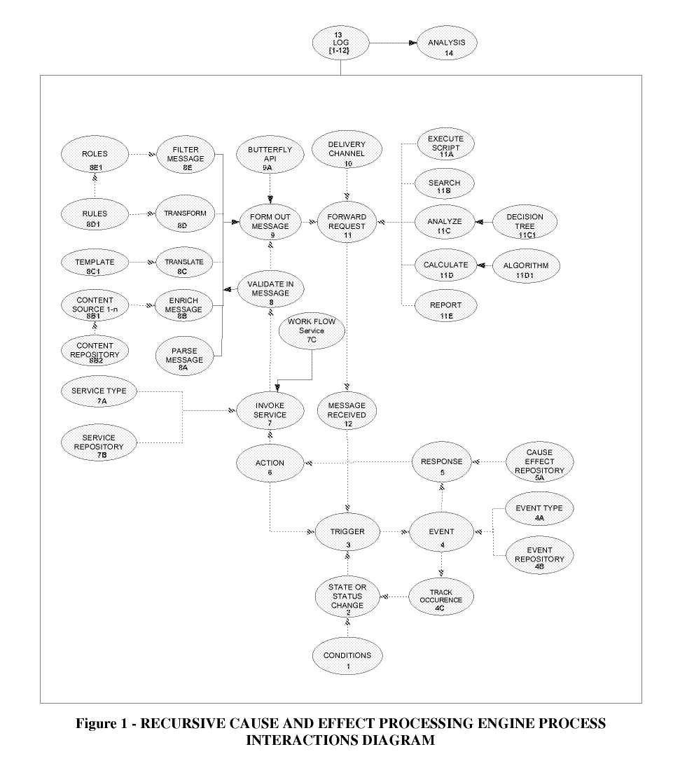

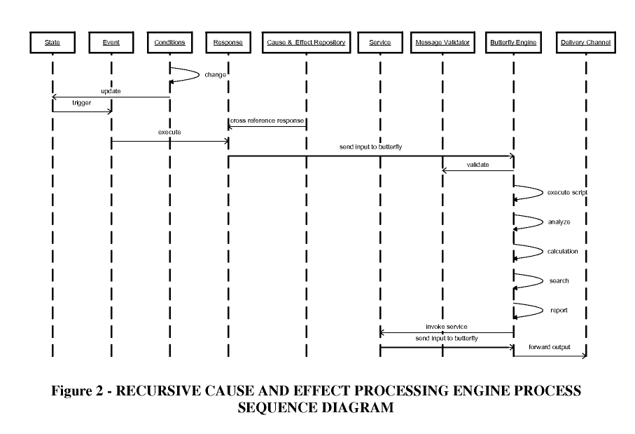

With respect to exemplary methods, apparatus, and products for the unique intelligent event-driven processing: this invention provides for a practical processing engine that can be easily adopted and configured and readily used by consumers in accordance with the present invention, as described with reference to the accompanying drawings (FIG. 1 and FIG. 2). Below is a descriptive example of the operating environment and interactions of this invention's internal processing:

### PROCESS DEFINITIONS AND SEQUENCES

### Mapped to FIG. 1

1. Conditions leading up to the triggering of an event to process data.
2. State-of-status change based on conditions changing.
3. Triggering of event base on status or state change.
4. Occurrence of a specific event.
4a. Event classified as a specific type event.
4b. Storage repository of all defined events.
5. Configured response to the specific defined event.
5a. Repository of cause and effect (what response is associated to what specific event).
6. Define actions (what to do) associated to a response to an event.
7. Invocation of a service method (operations) associated with that specific defined plan of action.
7a. Definition of service type categories.
7b. Repository of all service types defined.
7c. Workflow defined conditional sequence of 8-9.
8. Validation of message sent with the invoked service.
8a. Parsing of the message (so it can be prepared to process).
8b Enrichment of the message if it needs supporting content for understanding.
8b1. Content Source from where enrichment draws it content.
8c. Any necessary translation of the message before processing.
8c1. Template source repository (translate, algorithm embedded in template) from where that translation process reads instructions.
8d Any necessary transformation of the message.
8d1. Rules repository from where the transformation process reads for instruction.
8e. Any necessary filter of the message content.
8e1. Roles repository, associated to what rules apply to which consumer based on the defined roles.
9. Formatting of message output.
9a. Another input channel through this invention's API mapped to 9.
10. Delivery Channel—defines where to route request output from 9.
11. Forward request process—forwards output message to delivery channel defined in 10.
11a-e That forwarding request may need to invoke supporting services prior to augment of launch preparatory services before forwarding can be consumed the message such as:
11a. Executing a script to do some preparatory work.
11b. Conduct a search and use of the return results.
11c Analyze the updated contents of the message using decision tree logic algorithms (11c1).
11d calculate an algorithm (found in 11c1—repository of defined algorithms) driven by contents of message.
11e Report the message out to a defined reporting channel (send it anywhere according to its defined destination).

Once message is then routed (11), and is receipted by another service (12), that receipt of message then triggers (3) an Event (4), and the cycle repeats all over again unless the response (5) invokes an action (6) to terminate the cycle.

While all this interaction is occurring, each process transaction, routing message, and the state of message content are logged (13), enabling intelligence analysis to be performed and monitored on actual—not speculative—activity (14).

What is claimed is:

1. This invention provides the means for recursive or progressively recognized intelligent data processing.

2. This invention provides the means for recursive or progressively recognized decision-making, thus providing for the organic growth of an intelligent decision engine.

3. This invention provides a single source of process, data and integration.

4. In support of claim 1, this invention enables supply chain information efficiencies and 3rd party interdependencies by taking on data processing work through use of this recursive service.

5. In support of claim 2, this invention enables a basic standard for metering, and cost accounting resources per process.

6. In support of claim 2, this invention enables a standard base measurement unit for monitoring.

7. In support of claim 2, this invention provides a wealthy source of usage analysis, by providing actual transaction data, and input and output translation of the transaction.

8. In support of claim 3, this invention is platform-agnostic and is event- and data-driven, providing for simple flexible implementation.

9. In support of claim 3, this invention enables data integration across traditional logical and physical barriers.

10. In support of claim 3, this invention enables fully extensive enterprise data integration, thus opening up endless possibilities for the creation of hybrid information assets.

11. In support of claim 3, this invention provides for a multi-purposed integration hub.
